(19) United States
(12) Patent Application Publication
(10) Pub. No.: US 2024/0161053 A1
(43) Pub. Date: May 16, 2024

(54) COMPUTER IMPLEMENTED PRODUCT DELIVERY WITH FLEXIBLE PICKUP LOCATIONS

(71) Applicant: INTERNATIONAL BUSINESS MACHINES CORPORATION, Armonk, NY (US)

(72) Inventors: Saraswathi Sailaja Perumalla, Visakhapatnam (IN); Shailendra Moyal, Pune (IN); Sarbajit K. Rakshit, Kolkata (IN); Partho Ghosh, Kolkata (IN)

(21) Appl. No.: 17/988,246

(22) Filed: Nov. 16, 2022

(51) Int. Cl. G06Q 10/08

(52) U.S. Cl. CPC G06Q 10/0836; G06Q 10/0838

(57) ABSTRACT

Customer flexible pickup of product delivery that includes taking a product order from a customer to a merchant, wherein the customer provides a main delivery address, and providing pickup points to the customer for product delivery. Delivery vehicles with products for the product order are sent into transit. Customer instructions are received for at least one product of the product order to be delivered to at least one pickup point. At least one product is matched to the inventory in the delivery vehicles. Delivery vehicles are matched by inventory and location to the pickup point. At least one product is delivered to the at least one pickup point with matched delivery vehicle. A remainder of products in the product order are delivered to the main delivery address.

### BACKGROUND

The present invention generally relates to computer implemented product delivery, and more particularly to setting the destination of a product that is being delivered.

Traditionally, when a package is shipped, the package includes a shipping label that indicates both the consignee's name and the delivery address. The delivery address is a static physical location. However, the person identified as the consignee may not be at the delivery address during the time window when a package is scheduled to be delivered. Further, the person awaiting the shipment may wish to change the shipment address after the product has been initially shipped.

### SUMMARY

In accordance with one aspect of the present disclosure, methods, and computer program products have been provided for customer flexible pickup of product delivery.

In one embodiment, the computer implemented method for customer flexible pickup of product delivery includes receiving a product order at a computer from a customer to a merchant, wherein the product order includes a main delivery address, and the computer designates pickup points to the customer for product delivery that are different from the main delivery address. The method can further include communicating, using the computer, with delivery vehicles including products for the product order, wherein the delivery vehicles are sent into transit. In a following step, the method includes receiving at the computer customer instruction for at least one product of the product order to be delivered to at least one pickup point instead of the main delivery address while the product order is in transit. The computer implemented method can further match with the computer the at least one product of the product order in inventory in at least one of said delivery vehicles. In some embodiments, the method also includes matching with the computer at least one of said delivery vehicles having said at least one product in inventory to a location proximate to said at least one pickup point selected by the consumer. The method may also include communicating, using the computer, with the matched delivery vehicle to deliver at least one product to the at least one pickup point. In some embodiments, the method include communicating, using the computer, with the delivery vehicles to deliver a remainder of products in the product order to the main delivery address after deliveries to the at least one pickup point is completed.

In another aspect, a system is provided for customer flexible pickup of product delivery that includes a hardware processor; and a memory that stores a computer program product. The computer program product when executed by the hardware processor, causes the hardware processor to take a product order from a customer to a merchant, wherein the customer provides a main delivery address; and present pickup points to the customer for product delivery that are different from the main delivery address. The hardware processor can also send delivery vehicles with products for the product order into transit; and receive from the customer instruction for at least one product of the product order to be delivered to at least one pickup point instead of the main delivery address while the product order is in transit. The computer program product when executed by the hardware processor can also match the at least one product in inventory in at least one of said delivery vehicles; and match at least one of said delivery vehicles having said at least one product in inventory to a location proximate to said at least one pickup point selected by the consumer. The system can also deliver at least one product to the at least one pickup point with matched delivery vehicle; and deliver remainder of products in the product order to the main delivery address after deliveries to the at least one pickup point is completed.

In yet another aspect, a computer program product is provided for customer flexible pickup of product delivery. The computer program product can include a computer readable storage medium having computer readable program code embodied therewith. The program instructions are executable by a processor. The program instructions are executable by a processor to cause the processor to take a product order from a customer to a merchant, wherein the customer provides a main delivery address; and present pickup points to the customer for product delivery that are different from the main delivery address. The program instructions can also send, using the processor, delivery vehicles with products for the product order into transit; and receive, using the processor, the customer instruction for at least one product of the product order to be delivered to at least one pickup point instead of the main delivery address while the product order is in transit. The instructions can then match, using the processor, the at least one product in inventory in at least one of said delivery vehicles; and match, using the processor, at least one of said delivery vehicles having said at least one product in inventory to a location proximate to said at least one pickup point selected by the consumer. The method can continue with delivering, using the processor, at least one product to the at least one pickup point with matched delivery vehicle; and delivering, using the processor, a remainder of products in the product order to the main delivery address after deliveries to the at least one pickup point is completed.

### BRIEF DESCRIPTION OF THE DRAWINGS

The following description will provide details of preferred embodiments with reference to the following figures wherein:

FIG. 1 is an illustration of an example environment in which a customer has made an order from a merchant and a customer flexible pickup system allows for the customer to change delivery addresses for some products from the original main delivery address for the entirety of the order to a pickup location while the order is already in transit, wherein a remainder of the products in the order are still delivered to the original main delivery address, in accordance with one embodiment of the present disclosure.

FIG. 2 is a flow diagram showing a method for providing a customer flexible pickup of a product, in accordance with one embodiment of the present disclosure.

FIG. 3 is a flow/block diagram depicting a first embodiment of a system for providing customer flexible pickup of a product, in accordance with one embodiment of the present disclosure.

FIG. 4 is a generalized diagram of a neural network, in accordance with one embodiment of the present disclosure.

FIG. 5 is a block diagram illustrating a system that can incorporate the system for providing customer flexible pickup of a product that is depicted in FIG. 2, in accordance with one embodiment of the present disclosure.

FIG. 6 depicts a computing environment according to an embodiment of the present disclosure.

### DETAILED DESCRIPTION

The methods, systems, and computer program products described herein can provide for delivery system that allows for flexible pickup of the delivered product, i.e., the destination/delivery address can be changed while the product being delivered is in transit.

Generally, with delivery of products, if any product is already in transit, and during that time, if the customer changes his mind to pick the product from a nearby pickup point, if that pickup point is different from the originally designated delivery address, the customer will not be able to change the delivery address to the nearby pickup point of choice.

As will be described herein, the computer implemented methods, systems and computer program products that are described herein can allow a customer to order using an online order through the internet, and accordingly the delivery system will deliver the product to the customer location. However, the computer implemented methods, systems and computer program products that are described herein can also allow the customer to pick the product up from various pickup points, while the product being delivered is in transit. In the computer implemented methods, systems and computer program products of the present disclosure, the customer can specify an order of pickup points.

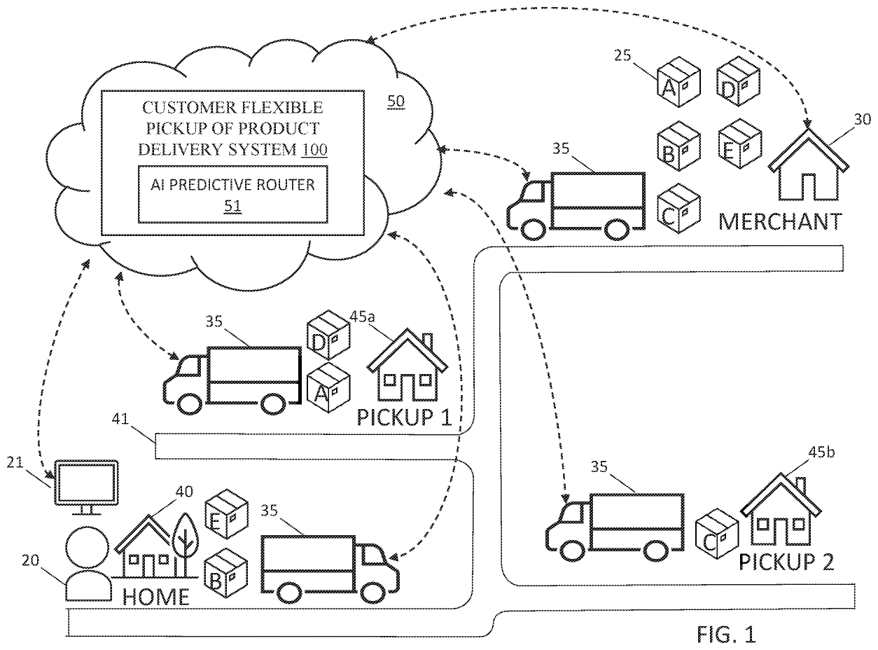

The methods and systems of the present disclosure are now described in greater detail with reference to FIGS. 1-6.

FIG. 1 in illustrations of an example environments to which the methods, systems and computer program products for providing intelligent service matching may be applicable. In the environment depicted in FIG. 1, a distributed computing system is applied to a delivery of goods application.

FIG. 1 is an illustration of an example environment in which a consumer 20 is purchasing products 25A, 25B, 25C, 25D, 25E from a merchant 30 at their location, e.g., distribution warehouse, to which the methods, systems and computer program products for customer flexible pickup of the product is applied. As illustrated in FIG. 1, the consumer 20 may make an online order, e.g., through the internet, by which the customer flexible pickup deliver system 100 may be applied. More particularly, the customer flexible pickup of product delivery system 100 may be a component of a distributed computing system. A distributed system is a computing environment in which various components are spread across multiple computers (or other computing devices) on a network. These devices split up the work, coordinating their efforts to complete the job more efficiently than if a single device had been responsible for the task. In some embodiments, the customer flexible pickup of product delivery system 100 is cloud based 50. A cloud based system, often known as cloud computing, is a broad term for anything that involves the delivery of hosted services via the internet. As illustrated, the consumer 20 may interact with the product delivery system 100 via a terminal that is in communication to the product delivery system, e.g., wirelessly, such as through the internet. Additionally, the cloud based 50 consumer flexible pickup of the product delivery system 100 may also be in communication with the merchant 30, as well as the delivery vehicles 35. The vehicles 35 may include global position system (GPS) tracking that helps to provide their location to the product delivery system 100.

After the customer 20 makes an order of product, e.g., products 25A, 25B, 25C, 25D, 25E, the merchant 30 loads the product on a delivery vehicle, e.g., delivery truck 35, for delivery to the customer 20. In this example, the consumer 20 is ordering five products identified by reference numbers 25A, 25B, 25C, 25D, and 25E. However, this is only one example, of the present disclosure, and it is not intended that the described computer implemented methods, systems and computer program products be limited to only this example. Any number of products may be included in the order.

Although, the order begins with a delivery address that corresponds to the main delivery address for the consumer 20, e.g., a consumer's residence (home) 40, the customer flexible pickup of product delivery system 100 provides that the consumer 20 can pick one or more products from the total order, and allows the consumer 20 to have those particular items delivered to a pickup point 45a, 45b that is different from the main delivery address 40. This can be done while the order is in transit. By “transit” it is meant that at least some of the products have been loaded onto a transportation vehicle and have left the distribution point of the merchant towards the physical location of the destination address, i.e., the main delivery address 40.

As noted above, the consumer 20, the merchant 30 and the transportation vehicles 35 are all in communication with the cloud based 50 product delivery system 100. This provides that in response to the request of the consumer 20 regarding specific instructions, the product delivery system 100 can selectively remove the products 25a, 25b, 25c, 25d, 25e that the consumer 20 wishes to receive at the pickup points 45a, 45b instead of at the main delivery address 40 for the original order of products, whereas the products that the consumer does not wish to change the delivery destination for continue to be delivered to the main delivery address 40, e.g., the consumer's residence (home) 40. For example, the consumer's 20 original order may include five products identified by reference numbers 25a, 25b, 25c, 25d, 25e, in which the main delivery address 40 for the order may have been the consumer's residence (home) 40. However, after the start of transit of the products, e.g., products the consumer 20 may wish to pickup specific products at different pickup points. In the example depicted in FIG. 1, two products 25a and 25d may be selected for delivery at a first pickup point 45a, whereas another product 25c may be selected for delivery at a second pickup point 45b. Still referring to FIG. 1, the remaining products 25e, 25b are still delivered to the main delivery address 40. These destination points are all selected by the consumer 20 through the customer flexible pickup of product delivery system 100, and may be updated in real time, and this remains the case once the shipment has been shipped, i.e., has left the merchant location 30.

Although FIG. 1 illustrates the same delivery truck identified by reference number 35 making all the deliveries to the different pickup points 45a, 45b and the main delivery address 40, this is only one example of how deliveries may be accomplished. In other embodiments multiple delivery trucks may be employed. This is particularly useful when the delivery trucks 35 maintain a stock of product type. In this example, different trucks 35 may be dispatched to different pickup points 45a, 45b, as well as the main delivery address 40. The different trucks 35 may all be in connection with the cloud based 50 customer flexible pickup of product delivery system 100 via the internet. The connection may be provided using cellular transmitters, e.g., 4G and/or 5G or other applicable standard. In some embodiments, because the different trucks 35 are connected to the delivery system 100, the delivery system knows the stock of the different trucks 35. Further, because of the connection between the different trucks 35, and the delivery system 100, the stock of the trucks 35 is updated in real time with the delivery system 100 after each delivery. Location of the different trucks 35 may be tracked using global positioning system (GPS) tracking. Because, the delivery system 100 has a real time stock of what products is present in the trucks 35, and the delivery system 100 has the location of the trucks 35, and this information is all available in real time, the delivery system 100 can provide the most efficient delivery of products from the trucks 35 to the pickup points 45a, 45b and the main delivery address 40.

Additionally, the system 100 can also provide for transfer products 25A, 25B, 25C, 25D, 25E between trucks 35. This allows for trucks 31 that are already on a route to a destination for one delivery to also deliver additional products to a pickup location that is in close proximity to their pre-planned destination.

Still referring to FIG. 1, in some embodiments, the customer flexible pickup of product delivery system 100 also includes an artificial intelligence (AI) predictive router 50. Based on historical data, geographic location, weather conditions, etc., the AI predictive router 50 can predict which products can be picked from pickup points 45a, 45b or a second delivery vehicle 35. Accordingly, the delivery vehicles 35 can keep additional stock of the products identified as being likely for delivery to the pick up points, which can serve to minimize truck to truck transfer of products.

In some embodiments, the customer flexible pickup of product delivery system 100 provides an interface 21 for the customer 20 through which while their order is being delivered the consumer 20 can selectively search which products 25A, 25B, 25C, 25D, 25E of their order they can pick for delivery at different pickup points 45a, 45b from different delivery vehicles 35.

In some embodiments, the customer flexible pickup of product delivery system 100 also provides for return of products from the customer 20.

In yet other embodiments, the proposed system can store immutable delivery geolocation, and involved delivery parties in a smart contract based blockchain environment. A “blockchain” is a growing list of records, called blocks, which are linked using cryptography. In some examples, each block contains a cryptographic hash of the previous block, a timestamp, and transaction data (generally represented as a Merkle tree). This can be advantageous for audit and tracking purposes.

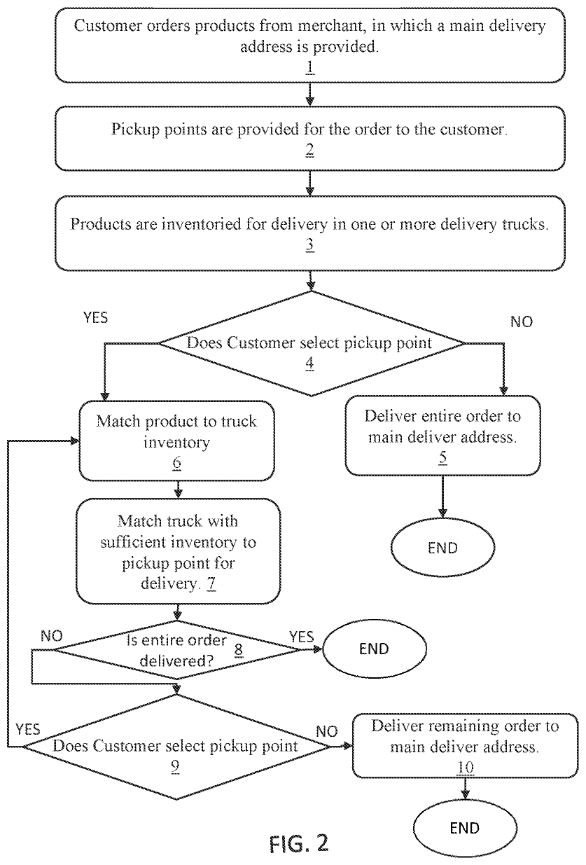

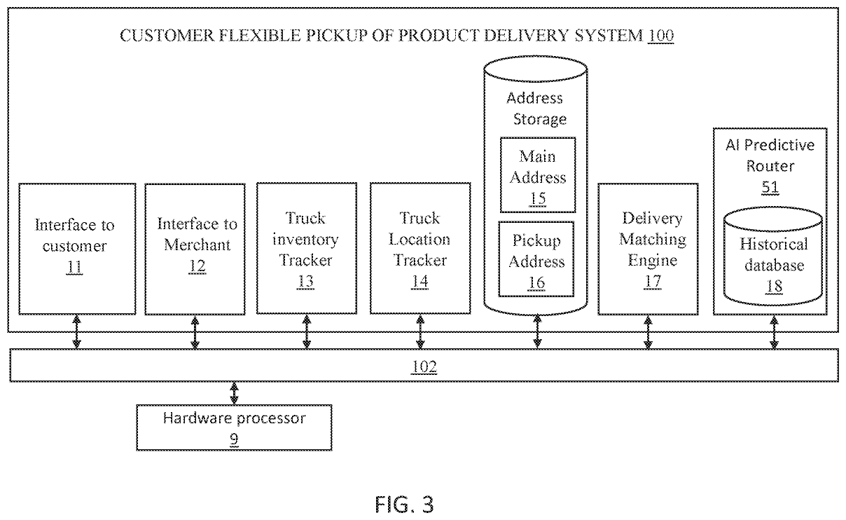

FIG. 2 is a flow diagram showing a method for providing a customer flexible pickup of a product. FIG. 3 is a flow/block diagram depicting a first embodiment of a system for providing customer flexible pickup of a product.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one embodiment, the computer implemented method for customer flexible pickup of product may include that a customer 20 orders products from merchant 30, in which a main delivery address 40 is provided at block 1 of the flow chart illustrated in FIG. 2. The customer flexible system 100 depicted in FIG. 3 includes an interface, e.g., customer interface 11, by which the customer 20 can make an order to the merchant 30. The merchant 30 also has an interface, e.g., interface to merchant 12, to the customer flexible pickup of product delivery system 100 through which the merchant 30 can receive the customer order. The customer order includes the products 25A, 25B, 25C, 25D, 25E that the customer 20 would like to purchase, as well as the customer's main delivery address. The “main delivery address” is the address that the customer requests at the time of the order for delivery of the product. The main delivery address could be the customer's 20 home or place of work. Still referring to FIG. 3, the system 100 also includes an address database. The address database may include a module of hardware memory for saving main addresses 15. Additionally, the system 100 also include provisions for block chain memory in the historical database 18.

Referring back to FIG. 2, in a following step, the method may include providing pickup points 45a, 45b for the order to the customer 20. A “pickup point” is an address that is other than the main delivery address at which the customer 20 may have the products of their order delivered. In some embodiments, the pickup points could be storefronts, delivery lockers, post offices, offices at which packages are mailed etc. Referring to FIG. 3, the system 100 includes an address database. The address database may include a module of hardware memory for pickup addresses 16. The customer flexible pickup of product delivery system 100 can compare the main delivery address with pickup point addresses that have been stored in the address database, and based on geographic proximity, the system 100 can provide pickup points to the customer 20 that are within close proximity to the customer 20, e.g., in close proximity to the main delivery address. Close proximity may be defined by the customer 20 as a maximum distance, e.g., a selected number of miles, from a location the customer selects, e.g., the main delivery address 40. The customer 20 can define close proximity at the time that the customer 20 makes the order of products 25A, 25B, 25C, 25D, 25E. through the customer interfaces 21, 11. Although close proximity can be measured from the main delivery address 40, this is not necessarily required. For example, the customer 20 may have proximity measured from a different address than the main delivery address, e.g., the customer 20 may define close proximity from a second residence that is not the main delivery address or a work location. Additionally, the customer 20 may change the proximity settings at any time. In some embodiments, the customer 20 may allow the system 100 to track the customer's geographic location. For example, the customer 20 may allows the system 100 to track the customer's phone. For example, referring to FIG. 3, the customer flexible pickup of product delivery system 100 may include a customer tracker 19, which may be a component of the interface to the customer 11. The customer tracker 19 may track the customer 19 using the customer's phone and GPS.

Similar to how the customer 20 defines close proximity through the customer interfaces 11, 21 to the system 100, the system 100 may provide pick up locations 45a, 45b to the customer 20 through the interfaces to the customer 11, 21.

Referring to FIG. 2, the computer implemented method can continue to the products 25A, 25B, 25C, 25D, 25E being inventoried for delivery in one or more delivery trucks 35. The merchant 30 in response to the order from the customer 20 loads delivery trucks 35 with the products 25A, 25B, 25C, 25D, 25E of the order. It is not necessary that a single truck delivery all products of the order. Additionally, trucks may already be in route that stock some products that the order contain. The merchant 30 is in communication with the system 100 through the merchant interface 12. Through this interface 12, the system 100 may be updated of what products are being loaded onto a truck, and the system 100 also include a truck inventory tracker 13, as illustrated in FIG. 3. The truck inventory tracker 13 maintains a list of the inventory of all trucks 35 from the merchant 30. This provides the possibility of a truck 35 already including some products of the order that is already on a delivery route. The truck 35 with the stock containing the designated products that is traveling on delivery routes can be rerouted as needed.

Referring to FIG. 2, the computer implemented method may receive continue with determining whether a customer 20 selects a pickup point 45a, 45b at block 4. The customer 20 may select a pickup point 45a, 45b for some products or all products in their order after the order has already started the shipping process. For example, the customer 20 may select a pickup point 45a, 45b after the products 25A, 25B, 25C, 25D, 25E of their order are already in transit for shipment, e.g., have left the merchant's 30 distribution center. The customer 20 can select pickup points 45a, 45b through the consumer interfaces 11, 21 to the customer flexible pickup of product delivery system 100. It is noted that although the methods, systems and computer program products of the present disclosure allow the customer 20 to select pickup points 45a, 45b, e.g., change delivery addresses for products 25A, 25B, 25C, 25D, 25E in an order, after the shipment is already in transit, the customer interface 11, 21.

If the customer 20 does not pick a pickup point at block 4, the delivery process continues with delivering all products to the customer 20 at the main delivery address 40 at block 5. This represents the end of the delivery process in the event that a customer 20 does not pick a pickup point 45a, 45b for any of the products 25A, 25B, 25C, 25D, 25E in their order.

If the customer 20 does pick a pickup point, e.g., pickup points 45a, 45b, at block 4, the computer implemented method may continue to matching products 25A, 25B, 25C, 25D, 25E to truck inventory at block 6. It is noted that following the customer 20 making the order, at any point in time, based on customer location or customer pickup point preferences, the consumer can select one or more products from their order to be picked up from a different pickup point than the main delivery address that was designated at the time of the order. In response to the designation of a pickup point 45a, 45b, the system locates all vehicles having the products in inventory for delivery at the pickup point. As noted above, the system 100 includes a truck inventory tracker 13. The trucks 35 are also in communication with the customer flexible pickup of product delivery system 100, which means that as the inventory of the trucks change, the system 100 is updated, and the information of the changing inventory is managed by the truck inventory tracker 13 depicted in FIG. 3.

At block 7 of the computer implemented method depicted in FIG. 2, the delivery method may continue to matching a truck 35 having matching inventory to the product that is selected for pickup at the pickup point 45a that is designated by the customer 20. For example, when the customer 20 has selected pickup point 1 45a for the delivery of products D and A (25D and 25A), trucks 35 having matching inventory and being proximate to the geographic location of the selected pickup point 1 45a are dispatched to deliver the selected products D and A (25D and 25A) to the selected pickup point 1 45a, as depicted in FIG. 1.

Referring to FIG. 3, as noted above, the customer flexible pickup of product delivery system 100 is in communication with the delivery trucks 35. The system 100 includes a truck inventory tracker 13 and a truck location tracker 14. The truck location may be tracked using GPS. The system knowing the truck inventory (e.g., from truck inventory tracker), truck location (e.g., from truck location tracker 14), as well as the address for the pickup address (e.g., stored in the pickup address module 15 of the address storage) can determine the most appropriate delivery vehicle 35 to meet the delivery requirements at the pickup point, and dispatches the delivery vehicle. The system 100 includes a delivery matching engine 17. The delivery matching engine may include one or more algorithms for matchings vehicles, inventories and locations at block 7.

The delivery matching engine 17 may include at least one module of memory including instructions for matching vehicles having matching inventories to the pickup points 45a, 45b, and at least one hardware processor 9 for performing the instructions in providing the matching step described in block 7 of FIG. 2.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The delivery matching engine 17 may be provided by some form or artificial intelligence providing device to determine matches. In some embodiments, the delivery matching engine 17 may include neural networks, expert systems, genetic algorithms, intelligent agents, logic programming, and fuzzy logic. Neural network artificial intelligence is based loosely upon the cellular structure of the human brain. Cells, or storage locations, and connections between the locations are established in the computer. As in the human brain, connections among the cells are strengthened or weakened based upon their ability to yield “productive” results. The system uses an algorithm to “learn” from experience. Neural nets are an inductive reasoning method. Expert systems are usually built using large sets of “rules.” Genetic algorithms utilize fitness functions, which are relationships among criteria, to grade matches.

In one example, the delivery matching engine 17 is an artificial neural network providing device. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

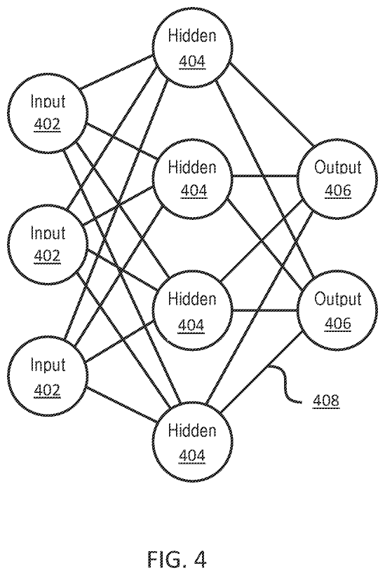

Referring now to FIG. 4, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 402 that provide information to one or more “hidden” neurons 404. Connections 408 between the input neurons 402 and hidden neurons 404 are weighted, and these weighted inputs are then processed by the hidden neurons 404 according to some function in the hidden neurons 404. There can be any number of layers of hidden neurons 404, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 406 accepts and processes weighted input from the last set of hidden neurons 404.

This represents a “feed-forward” computation, where information propagates from input neurons 402 to the output neurons 406. Upon completion of a feed-forward computation, the output is compared to a desired output available from training data. The error relative to the training data is then processed in “backpropagation” computation, where the hidden neurons 404 and input neurons 402 receive information regarding the error propagating backward from the output neurons 406. Once the backward error propagation has been completed, weight updates are performed, with the weighted connections 408 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. The training data can be provided by the data that is stored in the historical training database 18. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 408 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 408 may be implemented as resistive processing units (RPUs), generating a predictable current output when an input voltage is applied in accordance with a settable resistance.

As noted, the system 100 includes a historical database 18 of prior orders and how the deliveries were conducted, e.g., how trucks 35 were rerouted to meet the selection of pickup points 45a, 45b by the customers 20, and the selection of products 25A, 25B, 25C, 25D, 25E for delivery at the pickup points.

It is noted that the neural network is only one example of the type of artificial intelligence that can be employed by the delivery matching engine 17. It is noted that any type of machine learning is applicable. Machine learning (ML) employs statistical techniques to give computer systems the ability to “learn” (e.g., progressively improve performance on a specific task) with data, without being explicitly programmed. The machine learning method that can be used to suggestion mitigating steps in response to critical paths can employ decision tree learning, association rule learning, artificial neural networks, deep learning, inductive logic programming, support vector machines, clustering analysis, bayesian networks, reinforcement learning, representation learning, similarity and metric learning, sparse dictionary learning, genetic algorithms, rule-based machine learning, learning classifier systems, and combinations thereof.

In some embodiments, the image analyzer can analyze pin layouts using a machine learning algorithm that can be selected from the group consisting of: Almeida-Pineda recurrent backpropagation, ALOPEX, backpropagation, bootstrap aggregating, CN2 algorithm, constructing skill trees, dehaene-changeux model, diffusion map, dominance-based rough set approach, dynamic time warping, error-driven learning, evolutionary multimodal optimization, expectation-maximization algorithm, fastlCA, forward-backward algorithm, geneRec, genetic algorithm for rule set production, growing self-organizing map, HEXQ, hyper basis function network, IDistance, K-nearest neighbors algorithm, kernel methods for vector output, kernel principal component analysis, leabra, Linde-Buzo-Gray algorithm, local outlier factor, logic learning machine, LogitBoost, manifold alignment, minimum redundancy feature selection, mixture of experts, multiple kernel learning, non-negative matrix factorization, online machine learning, out-of-bag error, prefrontal cortex basal ganglia working memory, PVLV, Q-learning, quadratic unconstrained binary optimization, query-level feature, quickprop, radial basis function network, randomized weighted majority algorithm, reinforcement learning, repeated incremental pruning to produce error reduction (RIPPER), Rprop, rule-based machine learning, skill chaining, sparse PCA, state-action-reward-state-action, stochastic gradient descent, structured kNN, T-distributed stochastic neighbor embedding, temporal difference learning, wake-sleep algorithm, weighted majority algorithm (machine learning) and combinations thereof.

It is noted that the above examples of algorithms used for machine learning (ML)/artificial intelligence have been provided for illustrative purposes only.

In some embodiments, when the products 25A, 25D of the order that the customer 20 has selected for delivery to the first pickup point 45a are confirmed for delivery, the system 100 sends a notification to the customer 20 that the particular products 25A, 25D of the order have been rerouted from the main delivery address. The confirmation information may be forwarded to the customer 20 through the customer interfaces 11, 21. As the vehicles 35 are in communication with the system 100, the vehicles 35 may transmit when they have reached the pickup point 45a, and that information may be forwarded to the customer 20 through the customer interfaces 11, 21.

In some embodiments, upon the delivery vehicle 35 reaching the first pickup point 45a, the specified products, e.g., products A and D (25A, 25D), are unloaded for retention at the first pickup point 45a until the customer 20 reaches the pickup point 45a to take delivery of the products. In some examples, upon reaching the pickup point 45a, the delivery vehicle 35 receives a message from the system 100 including instructions regarding what products to deliver, e.g., products A and D (25A, 25D). In some embodiments, robotics may be employed to unload the selected products, e.g., products A and D (25A, 25D), at the pickup point 45a. This can provide an autonomous feature to the delivery method.

In some embodiments, in order for the customer 20 to take delivery of the products, e.g., products A and D (25A, 25D), the customer 20 may have to provide some form of identity upon reaching the pickup point 45a. For example, the customer 20 may be identified based upon biometrics, security key, customer identification (ID), billing information or a combination thereof.

In some embodiments, upon unloading of the products, e.g., products A and D (25A, 25D), from the at the pickup point, e.g., pickup point 45a, or upon customer 20 accepting delivery of the products, e.g., products A and D (25A, 25D), at the pickup point, e.g., pickup point 45a, the change in delivery status of the customer order, as well as the change in inventory status of the vehicle 35, is transmitted to the system 100. As noted the system 100 includes a truck inventor tracker 13 for tracking the inventory of the delivery vehicles 35. Further, the delivery of the specified products, e.g., products A and D (25A, 25D), at the pickup point, may also be recorded in the historical database 18. Delivery information may be stored in blockchain environment.

Referring to FIG. 2, in some embodiments, following delivery to the first pickup point, e.g., pickup point 45a (as depicted in FIG. 1), the computer implemented method may continue to determining whether the entirety of the order had been delivered to the pickup point 45a.

If the entirety of the order was delivered at the pickup point 45a at block 8, the delivery process ends, as the complete order has been delivered to the customer.

However, if the entire order has not been delivered at block 8, the method continues to determining whether the customer has selected an additional pickup point, e.g., pickup point 2 45b, for delivery of specified product, e.g., product C 25C. In the example depicted in FIG. 1, the customer 20 has selected a second pickup point, e.g., pickup point 2 45b. In this scenario, the computer implemented method may loop back to block 6. First, in response to the second selection of a pickup point 45b, the system 100 checks the inventory of the trucks 35 to determine, which trucks 35 have inventory to deliver the product specified by the customer 20 at the pickup point 45b. Thereafter, the computer implemented method continues to block 7 which includes matching a truck having the appropriate inventory to the pickup point for delivery. After delivery of the second set of products, e.g., product C 25C, from the original order to the second pickup point 45b, the system 100 can again check the status of the order.

If the entirety of the order was delivered at the first pickup point 45a and the second pickup point 45b at block 8, the delivery process ends, as the complete order has been delivered to the customer.

However, if the entirety of the order has not been delivered, the system 100 checks whether an addition pickup point has been designated, which would again cause the method to look back to blocks 6 and 7. If the customer 20 does not designate an additional pickup point, as illustrated in the Example depicted in FIG. 1., the remainder of the order is delivered to the main delivery address 40. Similar to the above described deliveries, truck inventory is checked, as well as truck location relative to the main delivery address 40, and the delivery matching engine 17 dispatches a delivery vehicle 35 having the appropriate inventory, and being in an appropriate geographic location to the main delivery address 40 at block 10.

In the example depicted in FIG. 1, the remainder of product, e.g., products 25E and 25B, are delivered to the main delivery address 40.

Similar to the deliveries at the first and second pickup points 45a, 45b, after the delivery of the remainder of products 25E, 25B at the main delivery address 40, the system 100 is updated with truck inventory and order status. The order delivery locations can be stored in the historical database 18. The historical database 18 can be used to train the artificial intelligence engine of the delivery matching engine 17.

In some embodiments, the system 100 also includes an artificial intelligence (AI) predictive router 51. The AI predictive router 51 may include a neural network, as described with reference to FIG. 4, which allows for AI predictive router 51 to identify from the product orders and deliveries stored in the historical database, which products are typically rerouted during delivery to pickup points 45a, 45, as opposed to which products are delivered directly to their main delivery address 40 as originally designated in the original product order. By creating this knowledge corpus, the system 100 can identify to the merchant 30 which products are typically rerouted to pickup points 45a, 45b. This information is helpful for identifying which products 25A, 25B, 25C, 25D, 25E should be considered for stocking delivery vans for onboard stock independent of specific order needs. By keeping these products on the vehicles, the delivery of these products can be achieved with greater flexibility.

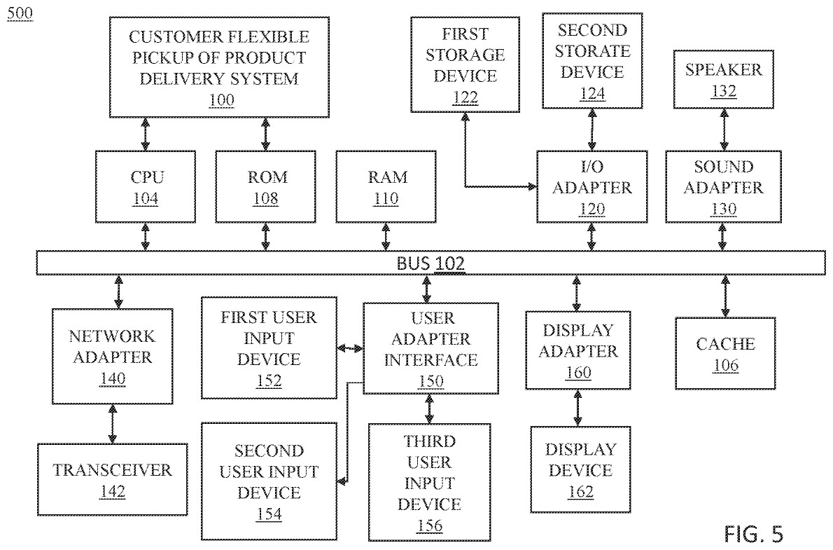

Referring to FIG. 3, in some embodiments, the components of the system 100 are interconnected by a bus 102. The bus 102 may also be in communication with at least one hardware processor, in which the hardware processor 9 may function with the other elements depicted in FIG. 3 to provide the functions described above. FIG. 5 further illustrates a processing system 500 that can include the customer flexible pickup of product delivery system 100 described with reference to FIGS. 1-3. The exemplary processing system 500 to which the present invention may be applied is shown in accordance with one embodiment. The processing system 500 includes at least one processor (CPU) 104 operatively coupled to other components via a system bus 102. The system bus 102 may be in communication with the system for ranking materials for post combustion carbon capture 200. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. As illustrated, the system 100 that provides for provenance based identification of policy deviations in cloud environments can be integrated into the processing system 400 by connection to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 500 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present invention provided herein.

The present invention may be a system, a method, and/or a computer program product at any possible technical detail level of integration. For example, in some embodiments, a computer program product is provided for customer flexible pickup of product delivery. The computer program product can include a computer readable storage medium having computer readable program code embodied therewith. The program instructions are executable by a processor. The program instructions are executable by a processor to cause the processor to take a product order from a customer to a merchant, wherein the customer provides a main delivery address; and present pickup points to the customer for product delivery that are different from the main delivery address. The program instructions can also send, using the processor, delivery vehicles with products for the product order into transit; and receive, using the processor, the customer instruction for at least one product of the product order to be delivered to at least one pickup point instead of the main delivery address while the product order is in transit. The instructions can then match, using the processor, the at least one product in inventory in at least one of said delivery vehicles; and match, using the processor, at least one of said delivery vehicles having said at least one product in inventory to a location proximate to said at least one pickup point selected by the consumer. The method can continue with delivering, using the processor, at least one product to the at least one pickup point with matched delivery vehicle; and delivering, using the processor, a remainder of products in the product order to the main delivery address after deliveries to the at least one pickup point is completed.

The computer program product may include a computer readable storage medium (or media) having computer readable program instructions thereon for causing a processor to carry out aspects of the present invention. The computer program produce may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

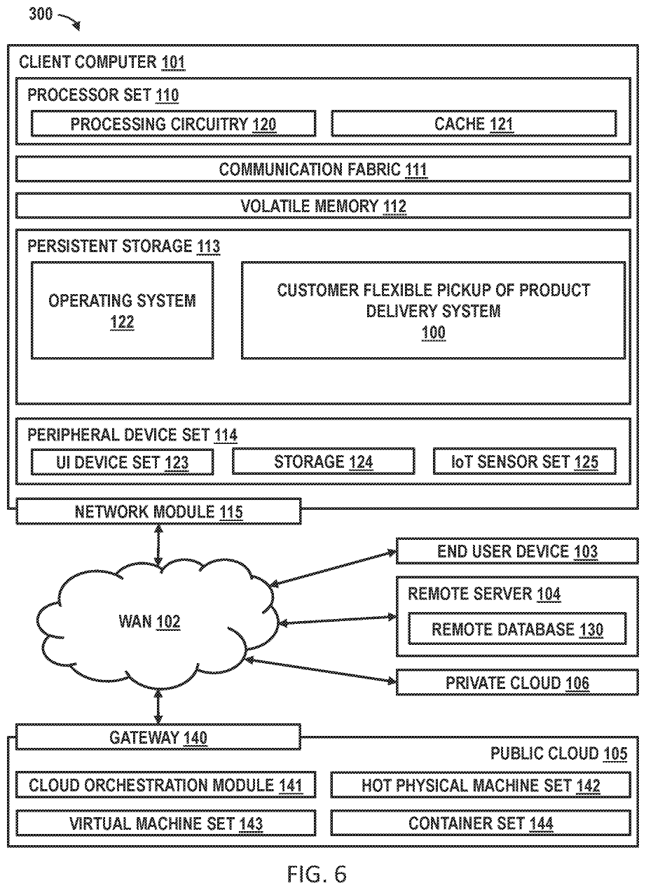

Referring to FIG. 6, the computing environment 300 contains an example of an environment for the execution of at least some of the computer code involved in performing the inventive methods, such as the method for customer flexible pickup of product delivery. In addition to block 200, computing environment 300 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 200, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 501, to keep the presentation as simple as possible.

Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 300, at least some of the instructions for performing the inventive methods may be stored in block 200 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 101 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 101 to communicate with other computers through WAN 102. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments,

EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for customer flexible pickup of product delivery (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer implemented method for customer flexible pickup of product delivery comprising:
receiving a product order at a computer from a customer to a merchant, wherein the product order includes a main delivery address, and the computer designates pickup points to the customer for product delivery that are different from the main delivery address;
communicating, using the computer, with delivery vehicles including products for the product order, wherein the delivery vehicles are sent into transit;
receiving at the computer customer instruction for at least one product of the product order to be delivered to at least one pickup point instead of the main delivery address while the product order is in transit;
matching with the computer the at least one product of the product order in inventory in at least one of said delivery vehicles;
matching with the computer at least one of said delivery vehicles having said at least one product in inventory to a location proximate to said at least one pickup point selected by the consumer;
communicating, using the computer, with the matched delivery vehicle to deliver at least one product to the at least one pickup point; and
communicating, using the computer, with the delivery vehicles to deliver a remainder of products in the product order to the main delivery address after deliveries to the at least one pickup point is completed.

2. The computer implemented method of claim 1 further comprising:
analyzing, with the computer, historical orders to determine which products have a greater likelihood of being sent to a pickup point in comparison to the main delivery address; and
maintaining, with the computer, an inventory of products having a greater likelihood of being sent to a pickup point on the delivery vehicles.

3. The computer implemented method of claim 1, wherein the delivery trucks include multiple delivery trucks in which a first delivery truck delivers the at least one product to the at least one pickup point, and at least a second delivery truck delivers the remainder of products to the main delivery address.

4. The computer implemented method of claim 1 further comprising tracking, with the computer, the delivery vehicles using global positioning system to determine which of the delivery vehicles are closest to the pickup points.

5. The computer implemented method of claim 1, wherein historical orders are recorded by the computer to train a matching engine for matching delivery vehicles with products matching a customer order to pickup up and main delivery addresses by geographic location.

6. The computer implemented method of claim 1 further comprising upgrading, with the computer, inventory in the delivery vehicles after deliveries to the pickup locations and the main delivery address.

7. The computer implemented method of claim 1, wherein providing pickup points to the customer includes selecting pickup points in response to a customer defined distance of proximity from the main delivery address.

8. A system for customer flexible pickup of product delivery comprising:
a hardware processor; and
a memory that stores a computer program product, the computer program product when executed by the hardware processor, causes the hardware processor to:
take a product order from a customer to a merchant, wherein the customer provides a main delivery address;
present pickup points to the customer for product delivery that are different from the main delivery address;
send delivery vehicles with products for the product order into transit;
receive from the customer instruction for at least one product of the product order to be delivered to at least one pickup point instead of the main delivery address while the product order is in transit;
match the at least one product in inventory in at least one of said delivery vehicles;
match at least one of said delivery vehicles having said at least one product in inventory to a location proximate to said at least one pickup point selected by the consumer;
deliver at least one product to the at least one pickup point with matched delivery vehicle; and
deliver remainder of products in the product order to the main delivery address after deliveries to the at least one pickup point is completed.

9. The system of claim 8 further comprising:
analyze historical orders to determine which products have a greater likelihood of being sent to a pickup point in comparison to the main delivery address; and
maintaining an inventory of products having a greater likelihood of being sent to a pickup point on the delivery vehicles.

10. The system of claim 8, wherein the delivery trucks include multiple delivery trucks in which a first delivery truck delivers the at least one product to the at least one pickup point, and at least a second delivery truck delivers the remainder of products to the main delivery address.

11. The system of claim 8 further comprising track the delivery vehicles using global positioning system to determine which of the delivery vehicles are closest to the pickup points.

12. The system of claim 8, wherein historical orders are recorded to train a matching engine for matching delivery vehicles with products matching a customer order to pickup up and main delivery addresses by geographic location.

13. The system of claim 8 further comprising to upgrade inventory in the delivery vehicles after deliveries to the pickup locations and the main delivery address.

14. The system of claim 8, wherein to provide pickup points to the customer includes selecting pickup points in response to a customer defined distance of proximity from the main delivery address.

15. A computer program product for customer flexible pickup of product delivery, the computer program product can include a computer readable storage medium having computer readable program code embodied therewith, the program instructions executable by a processor to cause the processor to:
take, using the processor, a product order from a customer to a merchant, wherein the customer provides a main delivery address;
present, using the processor, pickup points to the customer for product delivery that are different from the main delivery address;
send, using the processor, delivery vehicles with products for the product order into transit;
receive, using the processor, from the customer instruction for at least one product of the product order to be delivered to at least one pickup point instead of the main delivery address while the product order is in transit;
match, using the processor, the at least one product in inventory in at least one of said delivery vehicles;
match, using the processor, at least one of said delivery vehicles having said at least one product in inventory to a location proximate to said at least one pickup point selected by the consumer;
deliver, using the processor, at least one product to the at least one pickup point with matched delivery vehicle;
and
deliver, using the processor, remainder of products in the product order to the main delivery address after deliveries to the at least one pickup point is completed.

16. The computer program product of claim 15 further comprising:
analyze historical orders to determine which products have a greater likelihood of being sent to a pickup point in comparison to the main delivery address; and
maintaining an inventory of products having a greater likelihood of being sent to a pickup point on the delivery vehicles.

17. The computer program product of claim 15, wherein the delivery trucks include multiple delivery trucks in which a first delivery truck delivers the at least one product to the at least one pickup point, and at least a second delivery truck delivers the remainder of products to the main delivery address.

18. The computer program product of claim 15 further comprising track the delivery vehicles using global positioning system to determine which of the delivery vehicles are closest to the pickup points.

19. The computer program product of claim 15, wherein historical orders are recorded to train a matching engine for matching delivery vehicles with products matching a customer order to pickup up and main delivery addresses by geographic location.

20. The computer program product of claim 15 further comprising to upgrade inventory in the delivery vehicles after deliveries to the pickup locations and the main delivery address.
